(19) United States
(12) Patent Application Publication
(10) Pub. No.: US 2007/0120835 A1
(43) Pub. Date: May 31, 2007

(54) INPUT DEVICE AND SCROLL CONTROL METHOD USING THE SAME

(75) Inventor: Tadamitsu Sato, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/562,589

(22) Filed: Nov. 22, 2006

(30) Foreign Application Priority Data
Nov. 29, 2005 (JP) 2005-344491

(51) Int. Cl. G09G 5/00

(52) U.S. Cl. 345/173

(57) ABSTRACT

An input device is described, which is capable of quickly searching a part of information included in a large amount of continuous data (contents), and a scroll control apparatus using the input device. If a key input operation on one of the operation keys is performed through a key input unit while a low-speed scroll is being performed due to a slide operation performed on the key input unit, the low-speed scroll switches to a jump operation or a high-speed scroll. Thus, it becomes possible to quickly search a part of information included in a large amount of continuous data.

This application claims the benefit of Japanese patent application No. 2005-344491, filed on Nov. 29, 2005, which is incorporated herein by reference.

### BACKGROUND

1. Field of the Invention

The present application relates to an input device allowing both a coordinate input and a key input to be performed on one operation panel surface, and in particular, to an input device having improved operability and a scroll control method using the input device.

2. Description of the Related Art

JP-A-2005-149531 (at pages 30 to 33) discloses a technique of detecting an edge motion in which a sensing area of a touch sensor array is divided into two zones; that is, an inside zone as a central portion and an outside zone located outside the inside zone. A finger performing an operation that crosses the inside zone to reach the outside zone is detected by using a hardware processing unit or a software processing unit.

Since it is possible to scroll continuous screen information in a predetermined direction by using the edge motion function described above, even screen information, which is not currently displayed on a display screen, may be displayed.

In addition, JP-A-2003-162356 discloses a scroll control apparatus in which if a ‘long press’ is performed as an operation on a scroll key, an automatic scroll is performed, and if the ‘long press’ continues, the scroll speed increases corresponding to the continuing time.

In the case of viewing a large amount of continuous data, such as contents of a web site, in a small display screen of a portable terminal, it is necessary to scroll the screen.

However, in the related art disclosed in JP-A-2005-149531 (at pages 30 to 33), in the case when desired screen information is far away from current screen information, it is necessary to repeatedly perform an operation on the outside zone located to the direction of the desired screen information until the screen information is displayed. Accordingly, an operational problem occurs where the desired screen information cannot be displayed quickly.

In particular, in the case of the edge motion function, if an operation stops in the middle of the operation, an operation of returning to a screen on which the operation has started may occur. In this case, since it is necessary to perform an operation again from the beginning and the operation that has been performed until now is not effective, a problem exists in which an excessive load is applied to an operator.

Further, even in the related art disclosed in JP-A-2003-162356, it is necessary to perform the ‘long press’ with respect to a key switch continuously for a predetermined period of time and then to continue the ‘long press’ until the automatic scroll starts on a screen. In addition, since the operator needs to keep waiting until a screen reaches the desired screen information after the screen starts to be automatically scrolled, a problem occurs where the speed decreases in the same manner as described above.

### SUMMARY

An object of the invention to provide an input device, in which a search speed is fast and operability is excellent by complementing a coordinate input operation with a subsequent key input operation, and a scroll control method using the input device.

According to an aspect of the invention, an input device includes: a coordinate input mechanism of outputting a coordinate input signal based on a first input operation; and a key input mechanism of outputting a key input signal based on a second input operation. In this case, a low-speed scroll performed on the basis of the coordinate input signal is complemented by a key event performed on the basis of the key input signal generated after the coordinate input signal.

By performing a key input operation while the low-speed scroll due to a contact operation is being executed, a high-level scroll function is realized. As a result, it is possible to improve operability and convenience.

For example, the key event may be a jump operation or a high-speed scroll.

It is possible to perform a jump operation from the low-speed scroll to a predetermined location and to perform a switching operation from the low-speed scroll to the high-speed scroll. As a result, necessary information included in a large amount of continuous data can be found quickly.

Further, a plurality of operation keys are disposed in the key input mechanism and the jump operation or the high-speed scroll is performed in a direction corresponding to a position at which each of the operation keys is disposed.

Since the operation keys may be used as arrow keys, it is possible to perform the jump operation or the high-speed scroll freely in the direction that an operator intends.

Furthermore, as an operation corresponding to the second input operation is repeatedly performed, the speed of the high-speed scroll increases or decreases in a stepwise manner.

Since the speed of the high-speed scroll can be free to be changed, it is possible to improve the convenience particularly in the case of searching desired data of a large amount of continuous data.

In addition, the first input operation is a contact operation and the second input operation may be a key input operation.

Since the first input operation and the second input operation can be clearly distinguished, an erroneous operation due to an operator or an erroneous detection of an apparatus rarely occurs. As a result, the operability may be improved.

In addition, the first input operation and the second input operation are performed on the same operation surface.

Since it is not necessary to change an input device, the operability can be improved. In particular, in the case when the input device is mounted in a mobile phone, the second input operation may be performed by using operation buttons for dialing, and consequently, a dedicated key input mechanism is not needed.

Further, in another aspect, a scroll control method using an input device that has a coordinate input mechanism of allowing a coordinate input based on a first input operation and a key input mechanism of allowing a key input based on a second input operation includes: (a) determining whether or not the first input operation exists, (b) performing a low-speed scroll on the basis of the first input operation, (c) determining whether or not the second input operation exists, and (d) performing, if the second input operation exists during the performing of the low-speed scroll, an operation of jumping to a corresponding location.

Since it is possible to perform an operation of page-jumping to the location corresponding to the second input operation, it is possible to shorten the time required to find desired information.

Furthermore, in another aspect, a scroll control method using an input device that has a coordinate input mechanism of allowing a coordinate input based on a first input operation and a key input mechanism of allowing a key input based on a second input operation includes: (a) determining whether or not the first input operation exists, (b) performing a low-speed scroll on the basis of the first input operation, (c) determining whether or not the second input operation exists, (d) determining whether or not an edge motion is being performed, and (e) performing, if the edge motion is being performed and the second input operation exists during the performing of the low-speed scroll, an operation of switching from the low-speed scroll to a high-speed scroll.

It is possible to change the low-speed scroll to the high-speed scroll. As a result, it is possible to search desired information quickly.

In addition, it is possible to provide an input device, for example, which enables a part (small region) of information included in a large amount of continuous data to be searched quickly, and a scroll control method using the input device.

### BRIEF DESCRIPTION OF THE DRAWINGS

FIG. 1 is a block diagram schematically illustrating the configuration of a scroll control apparatus having an input device;

FIG. 2 is a view illustrating map information as an example of a large amount of continuous data;

FIG. 3 is a flow chart illustrating a case in which a jump operation is performed during low-speed scroll in a first example;

FIG. 4 is a flow chart illustrating a case in which low-speed scroll switches to high-speed scroll in a second example;

FIG. 5 is a view illustrating a screen of an address management program;

FIG. 6A is a view illustrating an initial screen of a schedule management program; and

FIG. 6B is a view illustrating a next screen subsequent to the screen of FIG. 6A.

### DETAILED DESCRIPTION

Reference will now be made in detail to embodiments. While the invention will be described in conjunction with these embodiments, it will be understood that it is not intended to limit the invention to such embodiments. In the following description, numerous specific details are set forth in order to provide a thorough understanding of the present invention which, however, may be practiced without some or all of these specific details. The same or equivalent elements or parts throughout the drawings are designated by the same reference characters.

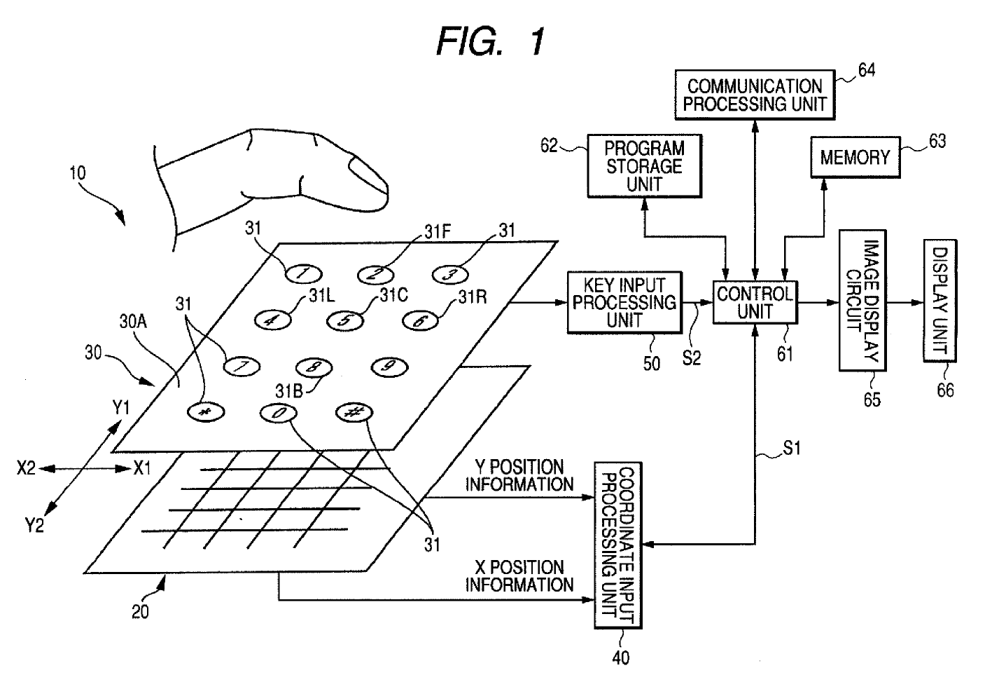

A scroll control apparatus (also referred to as a ‘display screen control apparatus’) 10 shown in FIG. 1 is configured to include an input device that has a coordinate input unit 20 and a key input unit 30 having at least one operation key 31.

The coordinate input unit 20 is formed by using a panel-type pointing device capable of detecting an input operation using a finger (alternatively, a pen or the like may be used). That is, the coordinate input unit 20 is capable of detecting predetermined position information (X position information and Y position information) on an operation surface (such as a case surface) 30A being contacted by the finger.

Types of the coordinate input unit 20 include a type using an electrostatic capacitance, a type using a resistive film, a type using infrared rays, a type using ultrasonic waves, or the like, and any of the types may be used.

For example, the key input unit 30 includes at least one operation key 31 and at least one key switch (not shown) configured to use a mechanical contact method and provided on the operation surface 30A so as to be freely pressed, and indicating marks (characters, symbols, or figures) that indicate details of an operation are printed on a surface (key top) of each operation key. By performing a key input operation of pressing the operation key 31, it is possible to output data corresponding to details shown on the key top. In addition, the coordinate input unit 20 and the operation surface 30A are provided within a case of, for example, a mobile phone (or portable terminal, or the like; not shown) so as to be stacked in the plate thickness direction.

In the following description, it is assumed that among a plurality of operation keys 31 shown in FIG. 1, one of the operation keys 31 having with an indicating mark ‘5’ is a central key 31C, one of the operation keys 31 having with an indicating mark ‘6’ is provided at the right side (X1) of the central key 31C is a right key 31R, one of the operation keys 31 having an indicating mark ‘4’ is provided at the left side (X2) of the central key 31C is a left key 31L, one of the operation keys 31 having an indicating mark ‘2’ is provided at the top side (Y1) of the central key 31C is a top key 31F, and one of the operation keys 31 having an indicating mark ‘8’ is provided at the bottom side (Y1) of the central key 31C is a bottom key 31B.

A ‘first input operation’ means an operation (contact operation) due to contact performed with respect to, mainly, the coordinate input unit 20. For example, in a state in which a finger is in contact with the operation surface 30A, the ‘first input operation’ includes a touch operation including a state in which a finger is placed on the operation surface 30A for more than a predetermined period of time, a tap operation including a state in which a finger is in contact with the operation surface 30A only for a short period of time, and a slide operation including a state in which a finger moves on the operation surface 30A. In addition, a ‘second input operation’ means an operation performed with respect to, the key input unit 30. The ‘second input operation’ includes a key input operation of pressing the operation key 31.

As shown in FIG. 1, the scroll control apparatus 10 includes a coordinate input processing unit 40 and a key input processing unit 50.

The coordinate input processing unit 40 has a function of performing a digital conversion with respect to position information (X position information and Y position information) being output from the coordinate input unit 20 and a function of communicating a coordinate input signal S1 obtained by converting the position information to plane coordinate signals (X coordinate signal and Y coordinate signal) to the control unit 61. The coordinate input unit 20 and the coordinate input processing unit 40 form a coordinate input mechanism.

If the key input processing unit 50 senses that a key switch is pressed through the operation key 31, the key input processing unit 50 has a function of informing the control unit 61 of a key input signal S2 that is the sensing result. The key input unit 30 and the key input processing unit 50 form a key input mechanism.

The scroll control apparatus 10 may also include, for example, a program storage unit 62, a memory 63, a communication processing unit 64 that performs a telephone function and a process of acquiring a electronic mail or a web page through communication with an external base station (not shown), an image display circuit 65, and a display unit 66.

The control unit 61 controls various processing operations performed by, for example, the coordinate input processing unit 40 or the communication processing unit 64 and performs image display in response to an input of the coordinate input signal S1 or the key input signal S2.

The program storage unit 62 stores an operating system and a variety of programs and serves to supply a processor executable software program to the control unit 61 in response to the control unit 61 so that the control unit 61 can perform a predetermined operation. That is, the program storage unit 62 stores a variety of programs for executing a coordinate input event performed on the basis of the coordinate input signal S1 and a key input event performed on the basis of the key input signal S2.

Examples of programs for the events described above, are a cursor program that causes a cursor (pointer) to be displayed and move on the display unit 66 in response to the coordinate input signal S1, a low-speed scroll program that cause a screen to continuously scroll-move at a low speed in response to the coordinate input signal S1 or a high-speed program that cause a screen to continuously scroll-move at a high speed in response to the coordinate input signal S1, a jump operation program that causes the screen to move up to a predetermined position at a time in response to the key input signal S2, an edge motion program that causes the scroll to continue even when a cursor (pointer) reaches an edge of the screen, a program that causes various functions, such as electronic mail (email), Internet functions such as World Wide Web (WWW), and telephone communication. to be executed, a program that causes a large amount of data (contents such as text, still image, or moving picture) on a email or a web site to be displayed on the display unit 66, a program that causes display details corresponding to the key input signal S2 to be extracted from a memory and then to be displayed on the display unit 66, and an address management program or a schedule management program.

The memory 63 has a function of preparing a work area necessary to perform the variety programs described above, a function of storing data related to contents of the acquired email or web pages, and a function of storing a variety of data, such as address data or schedule data.

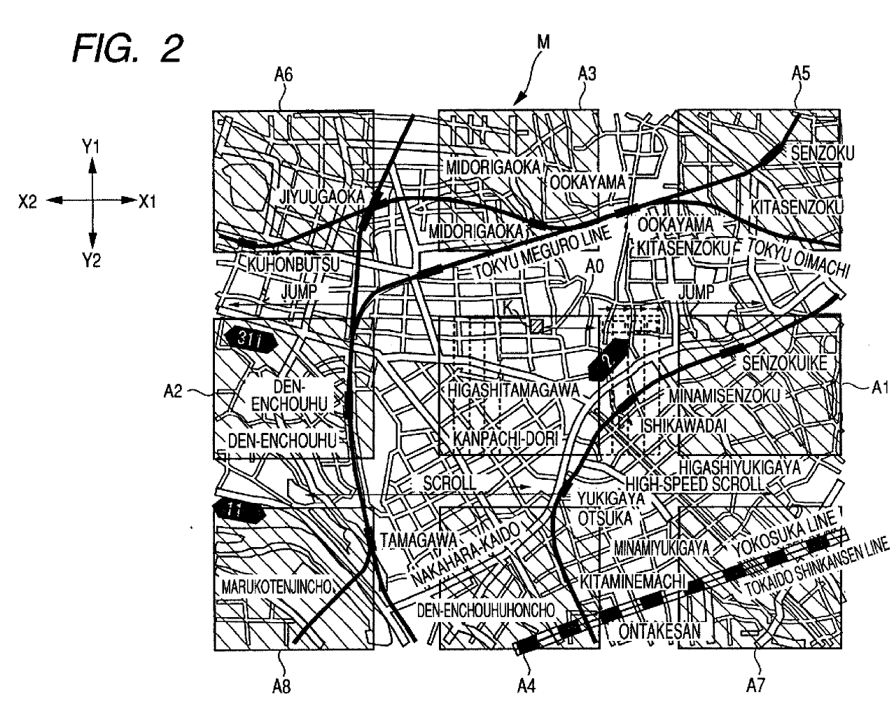

Examples of the operation of a scroll control apparatus having the input device will be described with reference to FIGS. 2, 3, and 4.

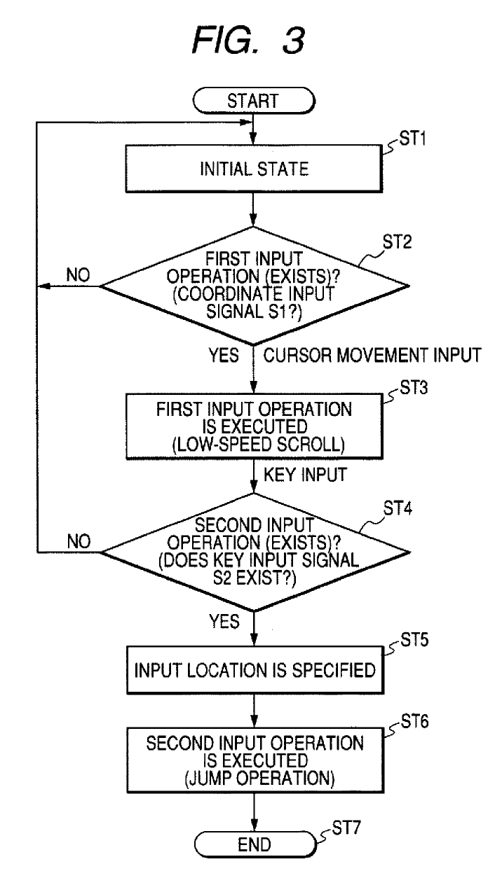

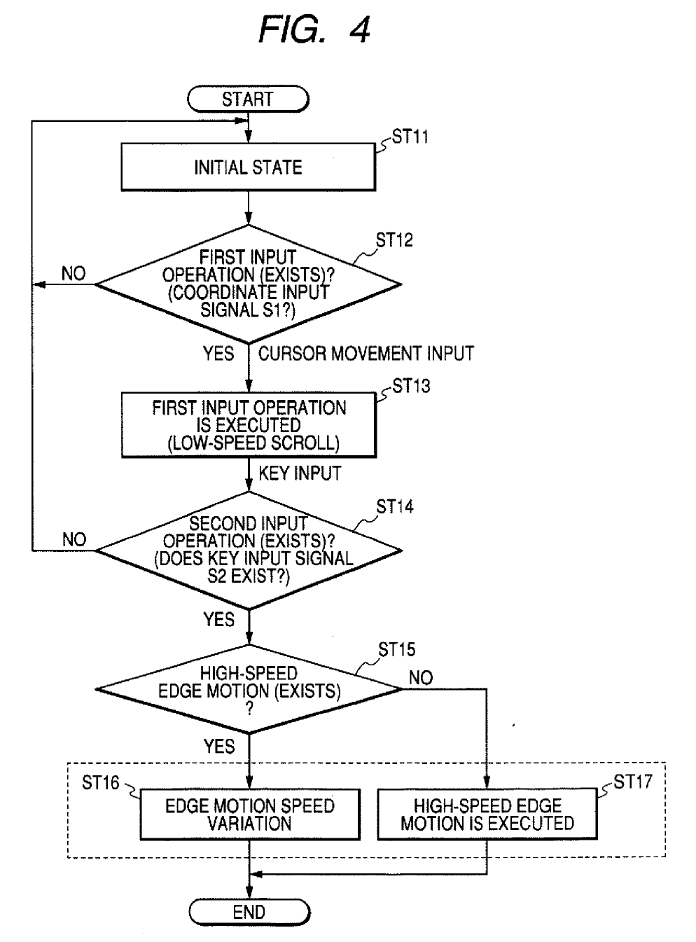

FIG. 2 is a view illustrating map information as a first example of a large amount of continuous data, FIG. 3 is a flow chart illustrating a case in which a jump operation is performed during low-speed scroll, and FIG. 4 is a flow chart illustrating a case in which low-speed scroll switches to high-speed scroll.

For example, a case is described in where a portable terminal having the scroll control apparatus acquires a large amount of continuous data, such as the map information data shown in FIG. 2, from a web site so as to be displayed on the display unit 66.

Map information data M is acquired through the communication processing unit 64 and is then stored in the memory 63.

The entire map information data M shown in FIG. 2 is a large amount of data included in the web site, and small regions A0, A1, A2, A3, A4, . . . , surrounded by small rectangles in the map information data M represent an amount of data that can be displayed at any one time by using the display unit 66.

The control unit 61 calls one small region onto a work area within the memory 63 from the map information data M, which is stored in the memory 63, in response to a request. Then, the small region called onto the work area is displayed on the display unit 66 through the image display circuit 65.

For example, the small region A0 corresponding to the central part of the map is called onto the work area and the small region A0 is displayed on the display unit 66.

In a first example, a jump operation is performed during low-speed scroll. A state in which the small region A0 shown in FIG. 2 is displayed on the display unit 66 is assumed to be an initial state (ST1).

In step ST2, whether or not the coordinate input signal S1 exists as a first input is checked (prior check). That is, when a finger is placed on the operation surface 30A, the coordinate input signal S1 indicating the position of the finger is communicated to the control unit 61 from the coordinate input processing unit 40 that forms the coordinate input mechanism, and the control unit 61 checks whether or not the coordinate input signal S1 has been communicated as the first input operation from the coordinate input processing unit 40. Then, in the case of ‘YES’ where the coordinate input signal S1 has been communicated as the first input operation, the process proceeds to step ST3. On the other hand, in the case of ‘NO’ where the coordinate input signal S1 is not yet communicated as the first input operation, the process proceeds to the initial state (ST1), and then, for example, an operation of waiting for the notification (coordinate input signal S1) from the coordinate input processing unit 40 is repeated until the notification.

In step ST3, the cursor program, the low-speed scroll program, or the like, are executed (first input operation execution). As a result of the execution of the cursor program, a cursor is displayed at the location on a screen corresponding to the location of the finger.

In addition, the low-speed scroll program as a coordinate input event is executed. With only information that the finger is placed, it is not evident in which direction the cursor should be moved. Accordingly, the scroll does not start with only the coordinate input signal S1 based on the first input operation.

Then, in step ST4, whether or not a second input operation performed through the key input unit 30 exists is checked. That is, if one of the operation keys 31 provided in the key input unit 30 is operated, the key input signal S2 indicating the information is communicated to the control unit 61 from the key input processing unit 50. The control unit 61 makes a determination on which operation key 31 the operation has been performed by checking details of the key input signal S2 communicated from the key input processing unit 50.

If an operation on one of the operation keys 31 is performed and the control unit 61 determines ‘YES’ with notification of the key input signal S2 from the key input processing unit 50, the process proceeds to a next step ST5 because the second input operation exists.

On the other hand, if the control unit 61 determines ‘NO’ where there is no notification (an operation on the operation key 31 has not been performed), the process returns to the initial state (ST1) because the second input operation has not been performed. Then, again in step ST2, it is checked whether or not the coordinate input signal S1 exists (next check). In the case of ‘YES’ in step ST2, the process proceeds to step ST3 and then it is checked again whether or not the key input signal S2 exists as the second input operation in step ST4. Then, in the case of ‘YES’ where the control unit 61 has received the key input signal S2, the process proceeds to step ST5 because the second input operation exists.

In step ST2, if details of the coordinate input signal S1 of the first input operation detected as the ‘next check’ is different from details of the coordinate input signal S1 of the first input operation detected as the ‘prior check’ before the ‘next check’, it means that the finger has moved between the ‘prior check’ and the ‘next check’. Thus, by using the details of the coordinate input signal S1 at the time of the ‘prior check’ and the details of the coordinate input signal S1 at the time of the ‘next check’, it is possible to calculate the moving direction of the finger.

Accordingly, in step ST3 subsequent to the ‘next check’, the moving direction of the finger is calculated by using the cursor program executed at the time of the ‘prior check’, and the cursor moves in the calculated direction. Moreover, in FIG. 2, for example, if a cursor moving in the X1 direction reaches an edge (end portion) within a small region such as A0, the cursor cannot move further in the moving direction of the finger. At this time, the low-speed scroll program is executed such that the screen (small region) scroll-moves on the map data M at a predetermined speed (first speed or initial speed v1) and in the moving direction of the finger (low-speed scroll).

That is, for example, if a finger touched on the operation surface 30A slides in the X1 direction, a cursor K moves within the small region A0 in the X1 direction and then reaches an edge (edge of the small region A0) of the display unit 66.

Subsequently, if the finger keeps moving in the X1 direction or if the finger is detached from the operation surface 30A and then the finger is placed again on the operation surface 30A and slides in the X1 direction, the cursor K stands still at the edge of the display unit 66 but a low-speed edge motion is executed in which only the small region A0 screen-slides in the X1 direction. Further, if the same operations (operations of sliding a finger in the X1 direction) are repeatedly performed, the same kind of screen slide is performed subsequent to the prior screen slide, and thus a low-speed scroll of passing the screen continuously and sequentially in the X1 direction. In addition, if these operations are repeatedly performed in the X1 direction, the small region A1 located at an end portion of the map information data M in the X1 direction can be finally displayed on the display unit 66.

In addition, the low-speed scroll as the coordinate input event described above is not limited to the X1 direction. For example, by causing a finger to slide in the X2 direction, Y1 direction, or Y2 direction, it is possible to perform the same kind of screen scroll.

If the key input signal S2 as the second input operation exists in step ST4, the process proceeds to step ST5. In step ST5, determination on the key input signal S2 is performed.

In step ST5, the operation key 31 by which the second input operation has been performed is specified (input location is specified) from details of the key input signal S2. Then, in step ST6, the jump operation program is called and executed (key event).

If the jump operation program as the key event is executed, the display position of the display unit 66 can move up to the location corresponding to the details of the key input signal S2, at a time.

The jump operation program as the key event may include a relative movement program that performs relative movement with respect to a small region being currently displayed and an absolute movement program that performs movement to a small region set in advance regardless of a small region being currently displayed.

Assuming that the jump operation program is the relative movement program, for example, in the case when the small region A3 is displayed on the display unit 66 in a first stage, the small region A5 located in the relatively right (X1) direction with respect to the small region A3 is displayed on the display unit 66 if the right key 31R attached with an indicating mark ‘6’ is operated as the second input operation in step ST4, the small region A0 located in the relatively back (Y2) direction with respect to the small region A3 is displayed on the display unit 66 if the back key 31B attached with an indicating mark ‘8’ is operated as the second input operation in step ST4, and the small region A4 located in the relatively back (Y2) direction with respect to the small region A5 is displayed on the display unit 66 if the back key 31B is consecutively operated.

Furthermore, in the case when the small region A3 is displayed on the display unit 66 in the first stage, if the central key 31C attached with an indicating mark ‘5’ is operated, the same display state (state in which the small region A3 is displayed) is maintained. In addition, even when the top key 31F attached with an indicating mark ‘2’ is operated, the same display state (state in which the small region A3 is displayed) is maintained because the map information data M located at the front (Y1) direction of the small region A3. Alternatively, new map information data M may be read out through communication using Internet.

In the case when the jump operation program is the absolute movement program, a small region set in advance is displayed regardless of a small region that is being displayed on the display unit 66 in the first stage. For example, the small region A0 is displayed on the display unit 66 if the central key 31C attached with an indicating mark ‘5’ is operated as the second input operation in step ST4, the small region A1 is displayed on the display unit 66 if the right key 31R attached with an indicating mark ‘6’ is operated as the second input operation in step ST4, the small region A2 is displayed on the display unit 66 if the left key 31L attached with an indicating mark ‘4’ is operated as the second input operation in step ST4, the small region A3 is displayed on the display unit 66 if the top key 31F attached with an indicating mark ‘2’ is operated as the second input operation in step ST4, and the small region A4 is displayed on the display unit 66 if the bottom key 31B attached with an indicating mark ‘8’ is operated as the second input operation in step ST4.

Furthermore, in the case of the absolute movement program, the operation keys 31 and the small regions correspond to each other in a one-to-one manner, Accordingly, operation keys 31, each of which is attached with an indicating mark ‘3’, ‘1’, ‘9’, or ‘7’, to the other small regions A5, A6, A7, and A8 may be respectively assigned.

As described above, it is possible to perform the low-speed scroll by performing the first input operation (coordinate input event).

In addition, by complementing the low-speed scroll, which is a coordinate input event based on the first input operation, with a jump operation, which is a key event based on the second input operation performed after the coordinate input event, a high jump operation to a predetermined small region that is desired becomes possible. As a result, an operator can acquire a desired map (small region) quickly, and the operator can search the desired map (small region) quickly.

In addition, since the first input operation and the second input operation can be performed on the same operation surface, the operability is improved.

In addition, by allowing the first input operation after the second input operation, it becomes possible to switch to the low-speed scroll at the location after the high jump operation. As a result, it is possible to reliably acquire the desired map (small region) and to improve the operability.

In a second example, the low-speed scroll switches to a high-speed scroll.

As shown in FIG. 4, steps ST11 to ST14 in the second example are the same as steps ST1 to ST4 in the first example, and are therefore not further described. In the second example, the description starts from step ST15. In addition, as a result of steps ST11 to ST14, a screen is in a low-speed edge motion state and a low-speed scroll state as a coordinate input event.

In step ST15, whether or not a high-speed edge motion program as a key event is in an executable state is determined.

In the case of ‘YES’ where the high-speed edge motion program is in the executable state, edge motion speed variation is performed (ST16), and in the case of ‘NO’ where the high-speed edge motion program is not in the executable state, a high-speed edge motion program is called and set as an active state (ST17).

In step ST16, the speed of the edge motion is changed on the basis of the second input operation (key input operation) in step ST14.

If the high-speed edge motion program as a key event is executed and, for example, the second input operation is performed with respect to the right key 31R attached with an indicating mark ‘6’, a high-speed edge motion is set where only a screen scroll-moves continuously in the X1 direction and at a predetermined second speed v2 faster than the first speed (initial speed) v1 of the low-speed scroll.

Further, the high-speed edge motion program may be set such that scroll movement becomes faster in a stepwise manner whenever the right key 31R is operated, for example, such that the screen scroll-moves in the X1 direction and at a third speed v3 faster than the second speed v2 if an operation on the right key 31R is performed subsequent to the previous operation and the screen scroll-moves in the X1 direction and at a fourth speed v4 faster than the third speed v3 if an operation on the right key 31R is repeatedly performed.

Furthermore, for example, if the second input operation is performed with respect to the left key 31L attached with an indicating mark ‘4’, which is located at a side opposite to the right key 31R, the fourth speed v4 may be reduced to the third speed v3. In addition, in the case when the central key 31C is operated, any scroll movement speed may return to the first speed (initial speed) v1.

In addition, it may be possible to scroll-move the screen in the X2 direction and at the first speed v1 if the left key 31L attached with an indicating mark ‘4’ is operated as the second input operation, to scroll-move the screen in the Y1 direction and at the first speed v1 if the top key 31F attached with an indicating mark ‘2’ is operated as the second input operation, and to scroll-move the screen in the Y2 direction and at the first speed v1 if the bottom key 31B attached with an indicating mark ‘8’ is operated as the second input operation. In addition, whenever the same operations are repeatedly performed, the scroll speed increases in a stepwise manner.

As described above, in the second example, it is possible to perform the low-speed scroll in the low-speed edge motion state by performing the first input operation (coordinate input event).

In addition, by performing the second input operation subsequent to the first input operation, it becomes possible to complement the low-speed scroll, which is a coordinate input event, with the high-speed scroll, which is a key event, and to increase the scroll speed. As a result, an operator can acquire a desired map (small region) quickly. That is, the operator can search the desired map (small region) quickly.

In addition, since the first input operation and the second input operation can be performed on the same operation surface, the operability can be improved.

In addition, by allowing the first input operation after the second input operation, it becomes possible to switch to the low-speed scroll at the location having reached at a high speed. As a result, it is possible to easily search the desired map (small region) and to improve the operability.

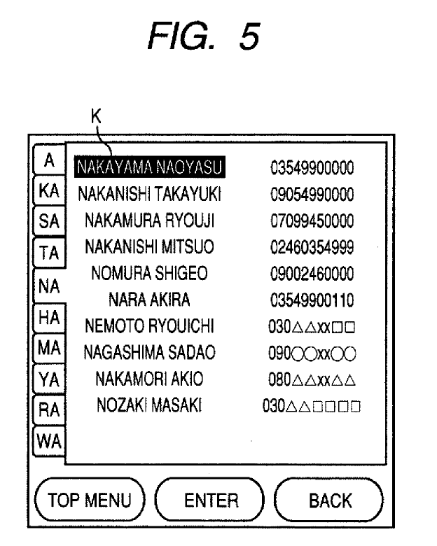

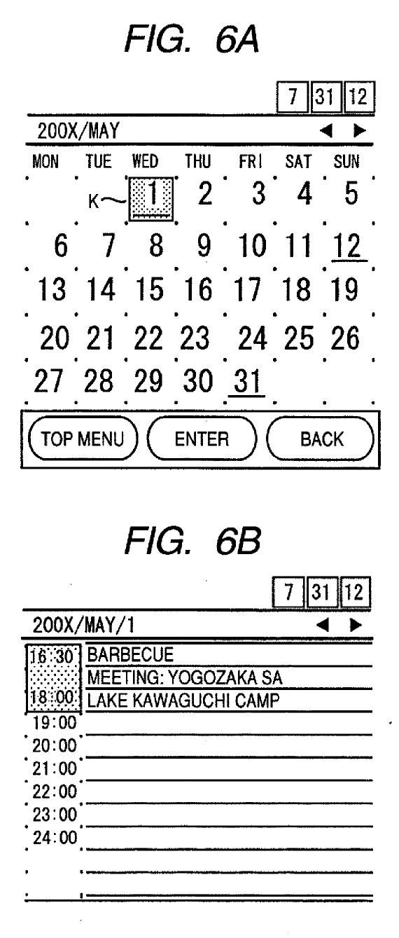

Another example having a large amount of data is described. FIG. 5 illustrates a screen of an address management program, FIG. 6A illustrates an initial screen of a schedule management program, and FIG. 6B illustrates a next screen subsequent to the screen of FIG. 6A. The memory 63 is configured to store schedule data and address data (data such as a names, a home address or an office address, a phone number, date of birth, an mail address, a fax number, or remarks, or similar information as may be found in a personal information manager or address book) with respect to hundreds or thousands of persons, as a large amount data.

The control unit 61 causes the address management program or the schedule management program to be executed when an operator presses the predetermined operation key 31, which is provided on the operation surface, or presses an address button (not shown) or a calendar button (not shown), which may be provided.

When the address management program is executed, for example, the control unit 61 retrieves data for ten persons, which are shown in FIG. 5 and are recorded at a ‘Na’ row of Japanese fifty syllabaries, from the large amount of address data stored in the memory 63 so as to be located in a work area within the memory 63, and then displays the names on the display unit 66. In addition, when the schedule management program is executed, for example, the control unit 61 retrieves a month calendar, which is shown in FIG. 6A and corresponds to a month to which the operation day belongs, from the schedule data stored in the memory 63 so as to be located in a work area within the memory 63, and then displays the retrieved calendar month on the display unit 66.

When a finger placed on the operation surface moves to perform the first input operation (ST3), the cursor program, the low-speed scroll program, and the like are executed as previously described. As a result of execution of the cursor program, the cursor K is displayed at the location on a screen corresponding to the location of the finger.

If the finger slides on the operation surface 30A in the Y2 direction, the cursor K moves in the Y2 direction. In the case of pressing, for example, a decision button at a location where the cursor K has stopped, a screen (not shown) indicating address data corresponding to name data displayed at the location is displayed while the address management program is being executed, and a schedule data screen corresponding to date data displayed at the location is displayed while the schedule management program is being executed (FIG. 6B).

When the cursor K moving in the Y2 direction reaches an edge of the displayed screen, the cursor K cannot further move in the moving direction of the finger. Accordingly, the low-speed scroll program is executed, and thus the screen is scrolled upward and new data is displayed at a lowermost end of the screen. That is, in an example in which the address management program is being executed, next name data subsequent to displayed name data located at the lowermost end of the display unit 66 is sequentially displayed, while name data located at an uppermost end of the display unit 66 disappears, being outside an area of the display unit 66.

In addition, in an example in which the schedule management program is being executed, date data of the next month not displayed on the display unit 66 is newly displayed from a first week on a weekly basis, while date data of a current month gradually disappears outside the area of the display unit 66 from a first week on a weekly basis. In addition, the scroll at this time is a low-speed scroll corresponding to the first speed or the initial speed v1.

In this state, if an operation on one of the operation keys 31 is performed as the second input operation, the control unit 61 calls the jump operation program or the high-speed edge motion program so as to execute a predetermined key event (ST6).

If the jump operation program as the key event is executed and, for example, the bottom key 31B is operated, the display position of the display unit 66 can move up to the location corresponding to details of the key input signal S2. For example, while the address management program is being executed, it is possible to perform an operation of jumping to last name data at the ‘Na’ row at a time, and while the schedule management program is being executed, a last month (December) of a year to which an operation day belongs is displayed on the display unit 66.

In addition, if the high-speed edge motion program as the key event is executed, the scroll is performed at a speed faster than the first speed. For example, while the address management program is being executed, the next name data subsequent to the name data displayed at the lowermost end of the display unit 66 is sequentially scrolled at high speed, and while the schedule management program is being executed, date data subsequent to the current month is sequentially scrolled at high speed on a weekly basis.

As described above, it is possible to perform the low-speed scroll in the low-speed edge motion state by performing the first input operation and to increase the speed of displaying different data by performing the subsequent second input operation so as to complement the low-speed scroll with a high-speed scroll or a jump operation which is a key event. As a result, an operator can acquire desired address data or schedule data quickly.

In the examples, switching from the low-speed scroll to the jump operation and the case of switching from the low-speed scroll to the high-speed scroll have been described; however, if the switching may be configured to switch from the high-speed scroll to the jump operation, and a search operation may be performed more quickly.

In addition, in the embodiments described above, the map information data M, the address data, and the schedule have been exemplified as an example of a large amount of continuous data; however, this is not intended as a limitation.

Although only a few examples of this invention have been described in detail above, those skilled in the art will readily appreciate that many modifications are possible thereto without materially departing from the novel teachings and advantages of the invention. Accordingly, all such modifications are intended to be included within the scope of this invention as defined in the following claims.

1. An input device comprising:
a controller configured to accept input from a coordinate input unit and a key input signal unit and to output a coordinate input signal based on a first input operation, and to output a key input signal based on a second input operation,
wherein a low-speed scroll performed on the basis of the coordinate input signal is modified by a key event performed on the basis of the key input signal generated subsequent to the coordinate input signal.

2. The input device according to claim 1,
wherein the key event is a jump operation or a high-speed scroll.

3. The input device according to claim 2,
wherein a plurality of operation keys are disposed in the key input mechanism, and the jump operation or the high-speed scroll is performed in a direction corresponding to a position of the operation key associated with the second input operation.

4. The input device according to claim 2, wherein when an operation corresponding to the second input operation is repeatedly performed, the speed of the high-speed scroll increases or decreases in a stepwise manner.

5. The input device according to claim 1, wherein the first input operation is a contact operation and the second input operation is a key input operation.

6. The input device according to claim 1, wherein the first input operation and the second input operation are performed on the same operation surface.

7. A scroll control method using an input device having a controller configured to accept input from a coordinate input unit and a key input signal unit and to output a coordinate input signal based on a first input operation, and to output a key input signal based on a second input operation, the method comprising:
determining whether or not the first input operation exists;
performing a low-speed scroll on the basis of the first input operation;
determining whether or not the second input operation exists; and
performing an operation of jumping to a corresponding location if the second input operation exists during the performing of the low-speed scroll.

8. A scroll control method using an input device having a controller configured to accept input from a coordinate input unit and a key input signal unit and to output a coordinate input signal based on a first input operation, and to output a key input signal based on a second input, the method comprising:
determining whether or not the first input operation exists;
performing a low-speed scroll on the basis of the first input operation;
determining whether or not the second input operation exists;
determining whether or not an edge motion is being performed; and
performing, an operation of switching from the low-speed scroll to a high-speed scroll if the edge motion is being performed and the second input operation exists during the performing of the low-speed scroll.
